(19) United States
(12) Patent Application Publication
(10) Pub. No.: US 2004/0122843 A1
(43) Pub. Date: Jun. 24, 2004

(54) XML browser markup and collaboration

(76) Inventors: John F. Terris, Saline, MI (US); Janet Erickson, Ann Arbor, MI (US); Karen Lease, Versailles (FR); Jurgen Lamera, Fahrenzhausen (DE); Andreas Struck, Munchen (DE); Krishna Mohan Rao Aerabati, Inkster, MI (US)

Correspondence Address: BAKER & HOSTETLER LLP, Washington Square, Suite 1100, 1050 Connecticut Avenue, N.W., Washington, DC, 20036, US

(21) Appl. No.: 10/322,513

(22) Filed: Dec. 19, 2002

(51) Int. Cl. G06F 17/00

(52) U.S. Cl. 707/102

(57) ABSTRACT

The present invention provides a method for document markup including the steps of: receiving a selected portion of a document, where the selected portion of document has a data position, receiving user input, and storing the user input and the data position of the selected portion of the document outside of the document.

### FIELD OF THE INVENTION

The present invention relates generally to a system for document markup and collaboration. More particularly, the present invention relates to a system for providing reviewer feedback for document collaboration through a web browser using a markup language such as XML.

### BACKGROUND OF THE INVENTION

While the means of accessing and using electronic reference materials have moved beyond the availability and relevance of printed documentation, the methods employed in document collaboration and in the creation and revision process have remained largely static. Prior markup and collaboration methods using reviewer feedback have not advanced beyond the methods used in authoring and revising a printed document. Thus there exists a need in the art for a system and improved method for document collaboration based on reviewer feedback.

For example, a typical automotive documentation project for a single vehicle can include 1,500 graphics, and 1,000 pages of text in 15 different languages. Approximately 40% of the documentation pages and graphics will be updated due to ongoing development of the vehicle during an automotive documentation project. The role of the author is now an ongoing role. The role of the author might be performed by several different people working from different locations over a period of several years. Printing out documentation and manually marking each page is not feasible on this scale.

There is also no guarantee that a marked up printed copy of a document is the current version of the document, because the comments are not linked to the document and can easily be lost, separated, or not delivered in a timely fashion.

There is a need in the art for an improved method and system for document markup and collaboration. One reason for this need is due to the considerable volume of documentation that must accompany or be available for each and every new device, product or service available. Even common items are subject to nearly constant revision and frequent replacement by an entirely new model. Traditional printed technical documentation has been largely supplanted by electronic versions thereof because printed materials cannot be updated or distributed with the frequency required to keep up with the pace of constant change. It is not unheard of for a technical reference manual to become obsolete before it is even published in printed form.

Reference documents available online and in electronic form can be updated and revised as often as needed, however, the methods that have been historically used to create and update electronic documentation are not without problems. The principle shortcoming with prior methods of creating, editing and revising both printed and electronic documentation is that prior methods lack an efficient system for document markup and collaboration based on reviewer feedback.

Another shortcoming of prior collaboration methods is in the difficulty associated with specifying and identifying the portion of a document that a reviewer's comments are referencing. Prior methods require the reviewer to specify the location that the feedback pertains which causes the reviewer to spend a considerable amount of time and energy describing where the problem is to the writer before describing the problem. Reviewer feedback is not useful or relevant without the context of a location. At the other end, the author is required to match reviewer feedback with the location specified by the reviewer. One of the shortcomings of prior systems is that the usefulness of reviewer feedback may depend on whether or not the reviewer clearly described the location of the document that the remarks are referencing. Another shortcoming of the prior system is that the relevance of reviewer feedback may also depend on whether or not, the author can determine the location the reviewer feedback pertains.

Prior markup and collaboration methods have not provided a way to consolidate reviewer feedback into a central location. Using a central user feedback location provides several advantages. Prior document collaboration methods have not employed a consistent mechanism for collecting reviewer feedback. Feedback from a reviewer may be sent to the author in any number of different formats, most of which involve manual handling and interpretation. Some of the formats presently used for user feedback communication include a number of different forms such as comments contained in email messages to comments written on printed copy of the document. Often comments are sent via a different communications channel from the one containing the document that the comments pertain.

Prior collaboration methods do not provide a satisfactory way to keep track of the status of reviewer feedback. Prior methods involve manually determining and then reporting the status of a comment. The shortcoming of prior methods is that manually reporting the status of a comment to one reviewer is difficult and involves tangential effort that takes away from document editing time. The level of difficulty and amount of time required to report the status becomes a more pressing issue when the author is required to keep multiple reviewers apprised.

Prior methods do not address providing prompt notice of the disposition of reviewer feedback. For example, a reviewer may not receive any indication of the disposition of a comment that they have submitted concerning a portion of a document. Prior methods do not provide a mechanism or a location that allows a reviewer to check the disposition feedback that they have submitted, short of contacting the author directly if even possible. Another problem with prior collaboration methods is that it is unlikely that a reviewer will receive timely indication or confirmation that their feedback was received.

In the case where a large volume of documentation has a broad reader base, prior markup and collaboration methods have not provided a satisfactory way for an end user reader to submit feedback about a document to an editor. In many cases a direct channel of communication does not exist between the reader and an editor of a document.

Prior collaboration methods do not provide a mechanism for determining the number of comments that have been submitted concerning a document or project. Moreover, prior markup and collaboration methods do not provide a way for users to categorize or classify the type of feedback that has been submitted. For example, prior methods do not provide a mechanism for a reviewer to indicate whether suggested revisions to a document are substantive, stylistic, or grammatical. An advantage of reviewer feedback classification is that a particular type of comment can be directed to an appropriate author for prompt resolution.

Prior collaboration methods do not provide a mechanism for dynamically generating and filtering views of stored comments in print or electronic form. Instead of storing electronic copies of comments, prior collaboration methods involve storing hard copies of comments made on paper which can be quite costly. Storage of hard copies of comments under prior methods require additional effort to retrieve a comment or to generate a report based on stored comments.

Accordingly, an electronic collaboration system that offers markup capabilities equivalent to what a reviewer currently does when the reviewer prints a certain document and adds comments to the printout by hand is desired.

In addition, an electronic collaboration system that is not susceptible to the cost, time-consumption and manual processes associated with prior collaboration methods, is also desired.

### SUMMARY OF THE INVENTION

The foregoing and other needs have been satisfied to a great extent by the present invention which includes a method and apparatus for document markup and collaboration.

The present invention provides a method for document markup including the steps of: receiving a selected portion of a document, where the selected portion of document has a data position, receiving user input, and storing the user input and the data position of the selected portion of the document separate from the document.

The present invention also provides an apparatus for document markup including a memory buffer having a first location and a second location; a display device that displays a document, where the display device is in communication with the memory buffer, and the document is stored in the first location of the memory buffer; and an input device that receives a selected portion of the document, where the selected portion has a data position and a corresponding user input, where the input device is in communication with the memory buffer and the corresponding user input and the data position of the selected portion are stored in the second location of the memory buffer.

The above and other features and advantages are achieved through the use of a novel method and apparatus as herein disclosed.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a distributed network according to one embodiment of the present invention.

FIG. 2 is an illustration of a client-server environment according to one embodiment of the present invention.

FIG. 3A is a block diagram illustrating a method of document markup and collaboration according to one embodiment of the present invention.

FIG. 3B is a block diagram illustrating a method of document markup and collaboration according to an alternate embodiment of the present invention.

FIG. 4A is an illustration of a client-server environment according to one embodiment of the present invention.

FIG. 4B is a block diagram illustrating a method of document markup and collaboration according to one embodiment of the present invention.

FIG. 5A is an illustration of a document displayed in a browser according to one embodiment of the present invention.

FIG. 5B is an illustration of an alternate view of a document displayed in a browser according to one embodiment of the present invention.

FIG. 5C is an illustration of XML source code of a document.

FIG. 6 is a flow chart illustrating a method of browser based markup and collaboration according to one embodiment of the present invention.

FIGS. 7A-B is a flow chart illustrating a method of browser based collaboration according to one embodiment of the present invention.

### DETAILED DESCRIPTION OF THE INVENTION

The present invention provides a method and system for browser based document markup and collaboration. The present invention provides a system and method of document collaboration with capabilities equivalent to a reviewer adding handwritten comments to a printed document without the shortcomings involved with handling and communicating handwritten comments to the appropriate person.

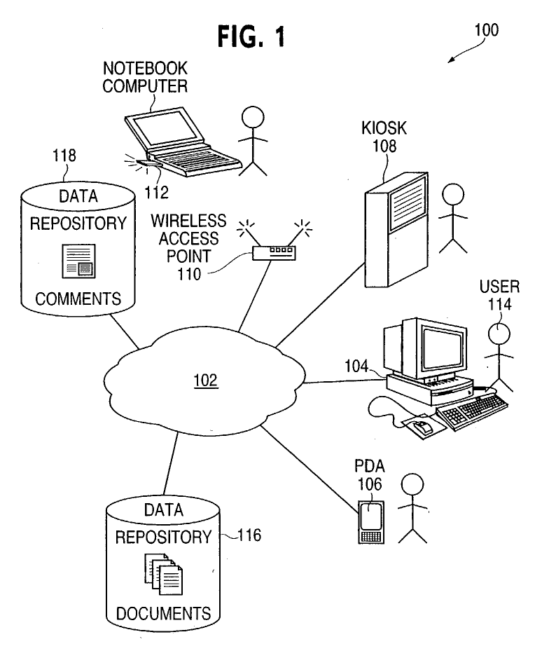

FIG. 1 is an illustration of a distributed network 100 according to one embodiment of the present invention. A distributed network 100 may be implemented as an intranet, a local area network (LAN), or a wide area network (WAN) such as the Internet. The distributed network 100 contains a network 102. The network 102 is the medium used to provide communications links between network connected devices and may include switches, routers, hubs, wired connections, wireless communication links, or fiber optic cables. Devices connected to the network 102 may include a computer 104, PDA (personal digital assistant) 106, kiosk 108, or WAP (wireless access point) 110. The WAP 110 may be used to provide a communication link between a portable notebook computer 112 and the network 102. Devices connected to the network may also contain a processor and memory for data storage. A user 114 may access a data repository containing documents 116 by using a network connected device such as a computer 104. A network connected device such as a computer 104, also allows the user 114 to submit feedback in the form of comments to a data repository containing comments 118 where the comments are stored. The user 114 may be a document reviewer with read-only access to the data repository containing documents 116. Alternatively, the user 114 may be an author or editor with document modification access to the data repository containing documents 116.

Those of ordinary skill in the art will appreciate that the hardware depicted in FIG. 1 may vary depending on the implementation of an embodiment present invention. For example, other devices, such as NAS (network attached storage) devices and the like, also may be used in addition to or in place of the hardware depicted. The depicted example is not meant to imply architectural limitations with respect to the present invention. One embodiment of the markup and collaboration system may be a stand-alone system without a network communication interface. Data repositories 116 and 118 may include memory and a data storage medium and may be in separate locations as depicted in FIG. 1, or in a single location such as a computer 104.

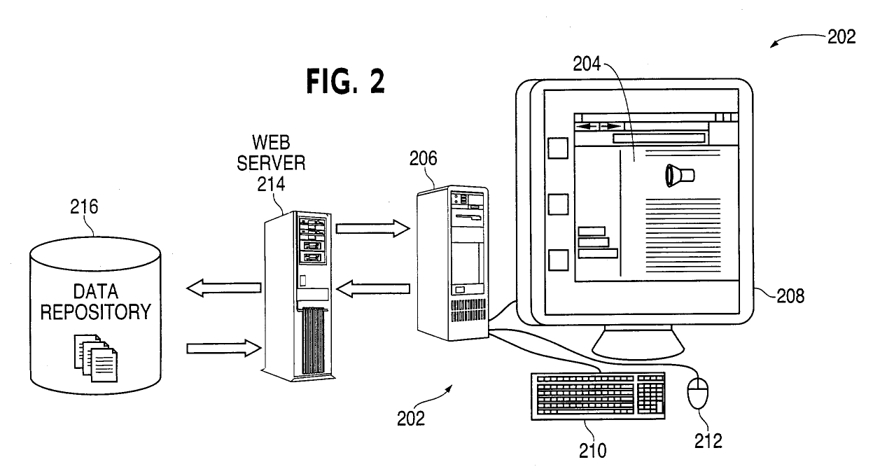

One embodiment of the present invention provides access to documents across a distributed network through a web browser. Documents are encoded as web pages using codes such as HTML (hypertext markup language) and a markup language such as XML (extensible markup language). FIG. 2 is an illustration of a client-server environment according to one embodiment of the present invention. This environment shows a client computer 202 running a web browser 204. The computer 202 may include a CPU (central processing unit) 206, a display device 208, and an input device such as a keyboard 210. A mouse 212 is another input device, though the term input device may include one or both of a keyboard 210 and mouse 212 or any other type of input device such as a key card or biometric scanner. An input device may be used to select portions of a document, to press buttons in a web page, and to select items from a pick list. The CPU 206 may contain a memory buffer, a data storage medium, a network interface card, and a processor. The computer 202 requests a document from a web server 214. The web server 214 requests data from a data repository 216 that constitutes the requested document. The data repository 216 sends the requested data to the web server 214. The web server 214 processes the data and renders it into an formatted document 208 using XML which is sent to the CPU 206 of the client computer 202. The CPU 206 sends the document to the display device 208 where it is displayed in the web browser 204.

A “client” should be broadly construed to mean any device connected to a network, or any device used to request or get a document. The client includes a browser such as a web browser like Microsoft Internet Explorer, Mozilla or Opera. The client browser further includes XML compatibility and support for application plug-ins or helper applications. The term “server” should be broadly construed to mean a computer, computer platform, an adjunct to a computer or platform, or any component thereof used to send a document or a file to a client.

Those of ordinary skill in the art will appreciate that the hardware depicted in FIG. 2 may vary depending on the implementation of an embodiment present invention. One embodiment of the markup and collaboration system may be a stand-alone system that is not connected to a network. In a stand-alone embodiment, both client and server functions occur on the same machine. The depicted example is not meant to imply architectural limitations with respect to the present invention.

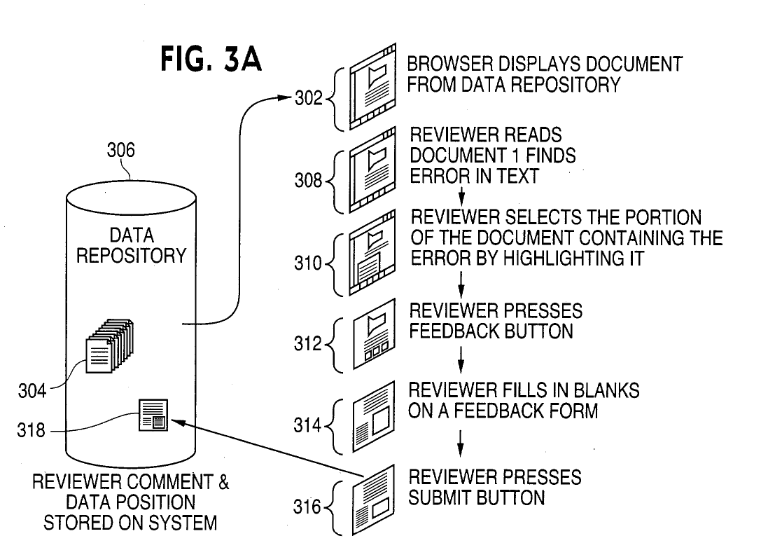

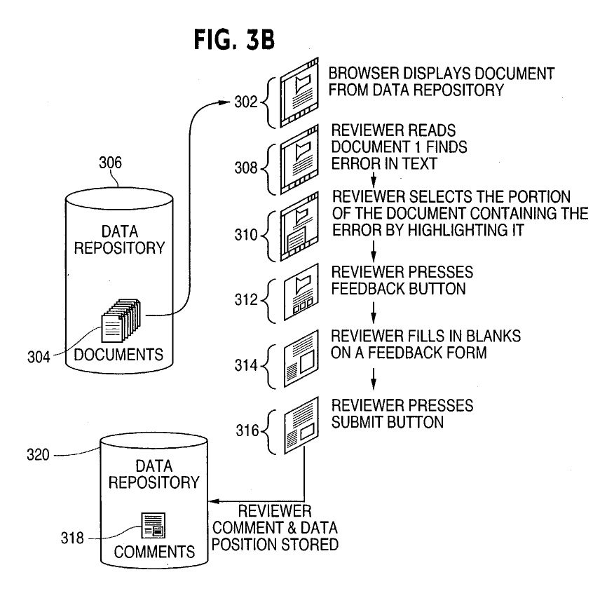

FIG. 3A is a block diagram illustrating a method of document markup and collaboration according to one embodiment of the present invention. In step 302, a browser displays a document 304 from a data repository 306. In step 308, a reviewer finds an error in the document 304. In step 310, the reviewer selects the portion of the document 304 containing the error by highlighting the error. The data position of the highlighted portion of the document 304 is stored in memory. In step 312, a feedback form is displayed when the reviewer presses a feedback button in the browser. In step 314, the reviewer enters feedback information about the error in the document 304 into the feedback form. In step 316, the feedback information and the data position are stored as a comment 318 in the data repository 306 when the reviewer presses the submit button on the feedback form.

It should be noted that according to one embodiment of the present invention, a comment 318 that corresponds to a document 304, may be stored separate from the document 304 when both the document 304 and the comment 318 are stored within the same data repository 306. A data repository 306 may be, but is not limited to, a server, file system, database, memory, hard drive or storage device. According to the instant embodiment, a comment 318 and document 304 may be stored as two separate objects within the same database record.

It should also be noted that, according to another embodiment of the present invention, the comment 318 may be stored within the document 304.

FIG. 3B is a block diagram illustrating a method of document markup and collaboration according to an alternate embodiment of the present invention. In step 302, a browser displays a document 304 from a data repository 306. In step 308, a reviewer finds an error in the document 304. In step 310, the reviewer selects the portion of the document 304 containing the error by highlighting the error. The data position of the selected portion of the document is stored in memory. In step 312, a feedback form is displayed when the reviewer presses a feedback button in the browser. In step 314, the reviewer enters feedback information about the error in the document 304 into the feedback form. In step 316, the feedback information and data position 318 are stored as a comment 318 in a data repository 320 when the reviewer presses the submit button on the feedback form.

Generally, FIGS. 3A and 3B illustrate a method according to the present invention that allows a client-side browser to communicate comment and feedback information to a document repository through a web server. An advantage of the single data repository 306 embodiment depicted in FIG. 3A is that the invention can be practiced with fewer devices than the embodiment depicted in FIG. 3B. Practicing the invention with fewer devices can be less expensive than practicing the invention with multiple devices. An advantage of the embodiment depicted in FIG. 3B is that having separate data repositories 306, 320 for documents 304 and comments 318 respectively, provides a broader range of security options such as locating the data repository 306 containing the documents 304 behind a network firewall that permits read only requests. FIG. 3B allows a user to add comments 318 to data repository 320. By placing the data repository 320 behind a network firewall that permits write requests to the data repository 320, a higher level of security can be achieved. Another advantage of the embodiment depicted in FIG. 3B is that having documents 304 and comments 318 stored in separate data repositories (306, 320) is better suited for a subscription based model of access to documents 304.

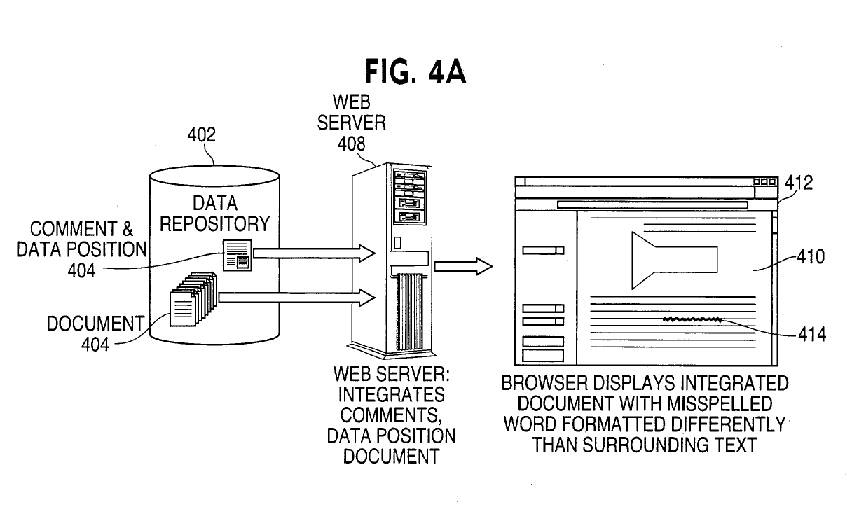

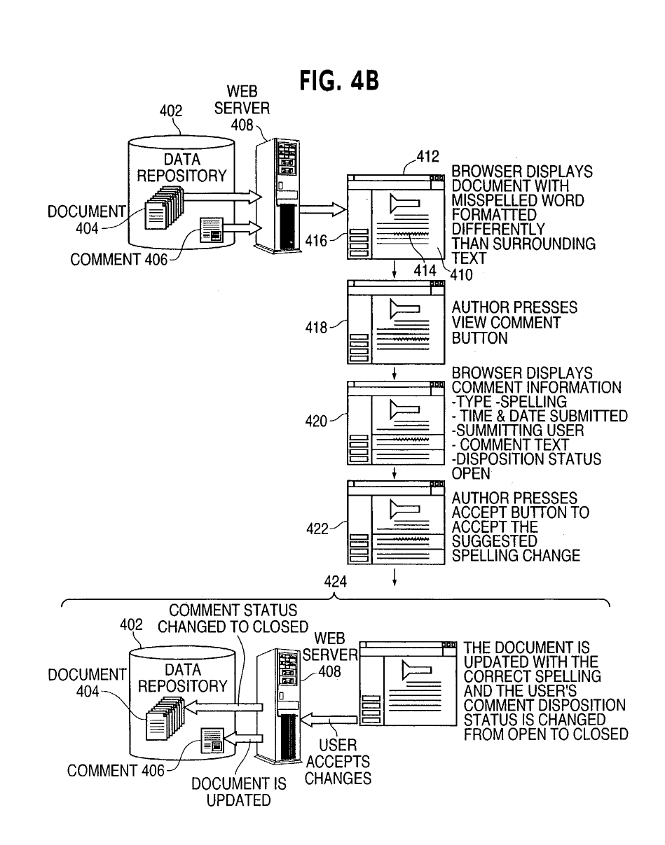

FIG. 4A is an illustration of a client-server environment according to one embodiment of the present invention. FIG. 4A shows a data repository 402 containing a comment with data position 404 and a document 406. The data repository 402 sends the comment with data position 404 and the document 406 to the web server 408. The web server 408 integrates the comment with data position 404 with the document 406 into a web page 410. The web server 408 sends the web page 410 to a client web browser 412. The client web browser 412 displays the web page 410. The commented portion of the document 414 appears with unique formatting in the web page 410. It should be appreciated by one skilled in the art that the document repository 402 and web server 408 may be or reside on the same server even though the servers are illustrated separately. It should also be appreciated by one skilled in the art that the client and server may be on a single machine performing all of the client and server processes.

FIG. 4B is a block diagram illustrating a method of document markup and collaboration according to one embodiment of the present invention. FIG. 4B shows a data repository 402 containing a comment with data position 404 and a document 406. The data repository 402 sends the comment with data position 404 and the document 406 to the web server 408. The web server 408 integrates the comment with data position 404 with the document 406 into a web page 410. The web server 408 sends the web page 410 to a client web browser 412. In step 416, the client web browser 412 displays the web page 410. The commented portion of the document 414 appears with unique formatting in the web page 410. In step 418, the user with editor access presses a view comment button in the client web browser 412. In step 420, the client web browser 412 displays information about the comment including comment classification, feedback information, name of comment submitter, date and time of submission and the comment disposition. In step 422, the user with editor access presses the accept button to accept the suggested spelling correction. In step 424, the document 406 is updated at the data repository 402 and the disposition of the comment with data position 404 is disposition is changed from open to closed.

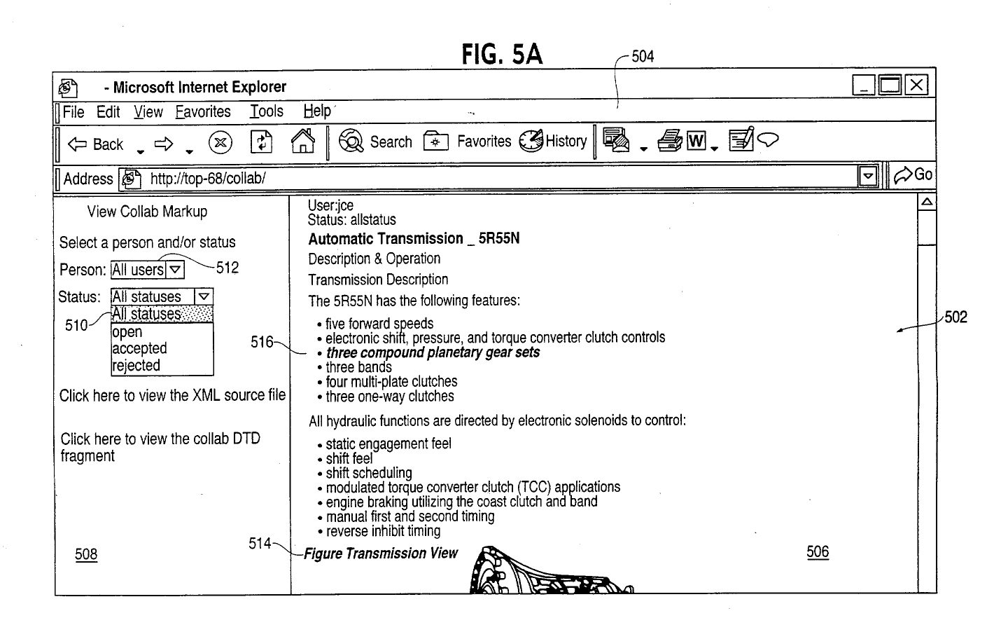

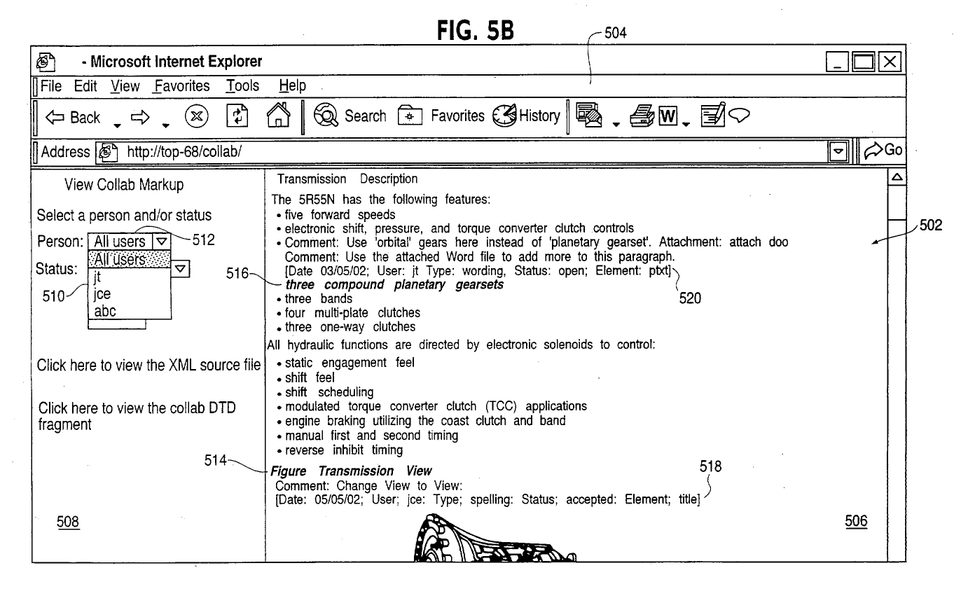

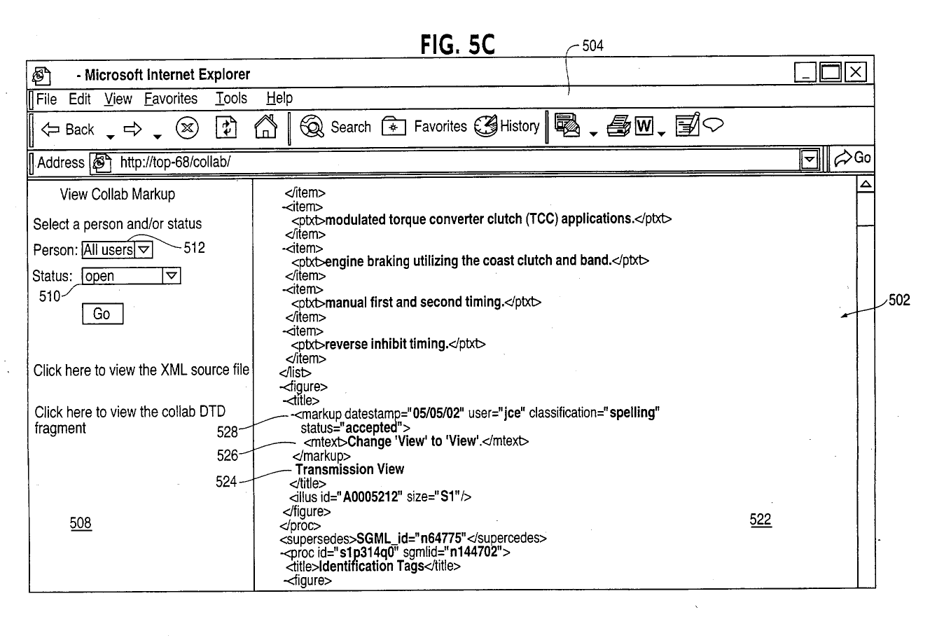

FIG. 5A illustrates a document displayed in a browser according to one embodiment of the present invention. FIG. 5A shows a web page 502 displayed in a web browser 504. The web page 502 contains a document 506 and a navigation panel 508. The navigation panel 508 contains a user selectable status list 510 and a user selectable list of users 512. The document 506 is part of the web page 502, and contains two portions of the document with unique formatting 514 and 516.

FIG. 5B illustrates a document displayed in a browser according to one embodiment of the present invention. In this view, a user has chosen the “all users” entry in the user selectable list of users 512 and the “all status” entry (not depicted) in the user selectable status list 510. Comments 518 and 520 appear below uniquely formatted sections 514 and 516 respectively.

FIG. 5C is an illustration of XML source code of a document. FIG. 5C shows XML code 522 displayed in a web browser 504.

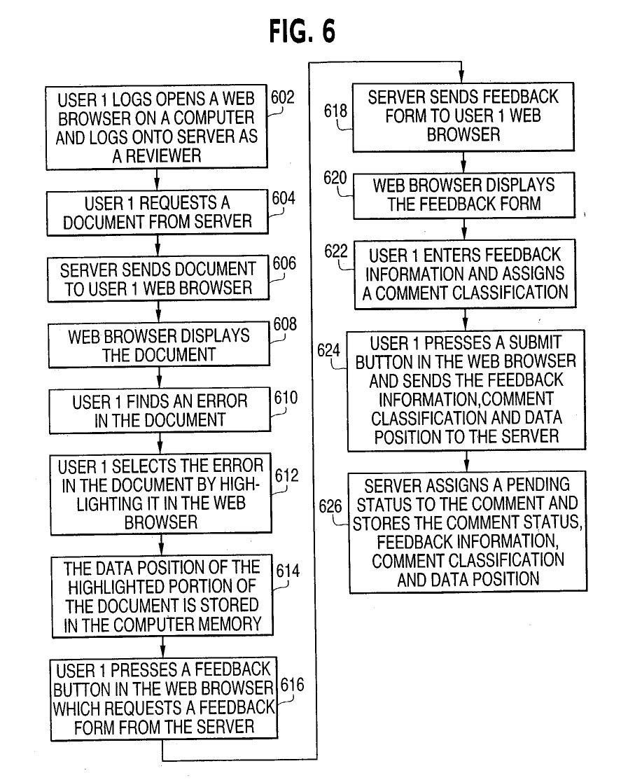

FIG. 6 is a flow chart illustrating a method of browser based collaboration according to one embodiment of the present invention. Starting with FIG. 6, in step 602, User1 opens a web browser on a computer and logs onto a server as a reviewer. User1, as a reviewer, has read-only document access. In step 604, User1 requests a document from the server. In step 606, the server sends the document to User1 in response to the request. In step 608, the web browser displays the document. In step 610, User1 finds an error in the document. In step 612, User1 selects the error in the document by highlighting it in the web browser. In step 614, the data position of the highlighted portion of the document is stored in the memory of the computer. In step 616, User1 presses a feedback button in the web browser which requests a feedback form from the server. In step 618, the server sends the feedback form to User1's web browser. In step 620, the browser displays the feedback form. In step 622, User1 enters feedback information and assigns a comment classification. In step 624, User1 presses submit button in the web browser and sends the feedback information, comment classification and data position to the server. In step 626, the server assigns and stores a pending comment status and stores the feedback information, comment classification, and data position.

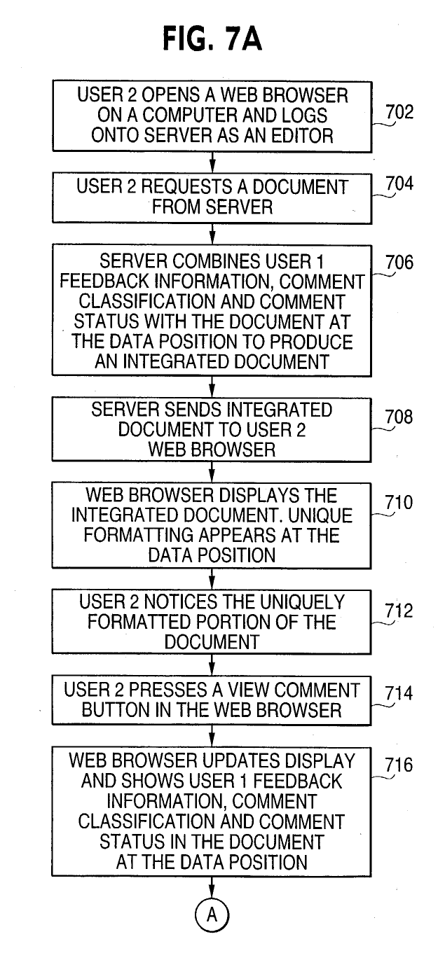

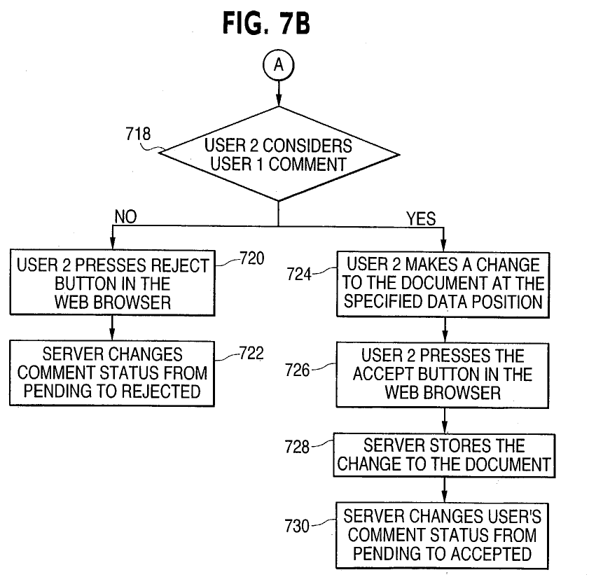

FIGS. 7A-B is a flow chart illustrating a method of browser based collaboration according to one embodiment of the present invention. In step 702 of FIG. 7A, User2 opens a web browser on a computer and logs on to the server as an editor. As an editor, User2 has read and write access to documents. In step 704, User2 requests a document from the server. In step 706, the server combines User1's feedback information, comment classification, and comment status with the requested document at the data position to produce an integrated document. In step 708, the server sends the integrated document to User2's web browser. In step 710, the web browser displays the integrated document. Unique formatting appears at the data position. In step 712, User2 notices the uniquely formatted portion of the document. In step 714, User2 presses a view comment button in the web browser. In step 716, the web browser updates the display and shows User1 feedback information, comment classification, and comment status in the document at the specified data position. Turning to FIG. 7B, in step 718, User2 considers User1's comment. If User2 rejects the comment, User2 presses the reject button in the web browser (step 720) and the server changes User1's comment status from pending to rejected (step 722). If User2 accepts User1's comment, then User2 makes a change to the document at the data position in step 724. In step 726, User2 presses the accept button in the web browser. In step 728, the server stores the change to the document. In step 730, the server changes User1's comment status from pending to accepted.

According to one embodiment of the present invention, the method is implemented as a computer program, namely, as a set of instructions executed by a processor. Thus, for example, the method may be a Java applet, a browser plug-in, a standalone application written in native code, a distinct process built into the web browser, or part of the integral web browser functionality. One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A method for document markup comprising:
receiving a selected portion of a document, said selected portion having a data position;
receiving user input;
storing said user input and said data position of said selected portion separate from said document.

2. The method of claim 1 wherein said user input and said data position of said selected portion are stored in a central location.

3. The method of claim 1 further comprising the step of:
integrating said user input into said document at said data position.

4. The method of claim 3 further comprising the step of:
displaying said selected portion differently than the rest of said document.

5. The method of claim 1 wherein the step of storing said user input and said data position further comprises storing said user input and said data position in a data repository.

6. The method of claim 1 further comprising the step of:
integrating said user input into said document at said data position using an extensible markup language.

7. The method of claim 1 further comprising the step of:
indicating said user input and said data position of said selected portion have been stored.

8. A system for document markup comprising:
means for receiving a selected portion of a document, said selected portion having a data position;
means for receiving user input;
means for storing said user input and said data position of said selected portion separate from said document.

9. The system of claim 8 wherein said means for storing said user input and said data position of said selected portion further comprises means for storing said user input and said data position of said selected portion in a central location.

10. The system of claim 8 further comprising:
means for integrating said user input into said document at said data position.

11. The system of claim 10 further comprising:
means for displaying said selected portion differently than the rest of said document.

12. The system of claim 8 wherein the means for storing said user input and said data position further comprises means for storing said user input and said data position in a data repository.

13. The system of claim 8 further comprising:
means for integrating said user input into said document at said data position using an extensible markup language.

14. The system of claim 8 further comprising:
means for indicating said user input and said data position of said selected portion have been stored.

15. An apparatus for document markup comprising:
a memory buffer having a first location and a second location;
a display device that displays a document, said display device in communication with said memory buffer, said document being stored in said first location of said memory buffer; and
an input device that receives a selected portion of said document, said selected portion having a data position and a corresponding user input, said input device in communication with said memory buffer, said corresponding user input and said data position of said selected portion being stored in said second location of said memory buffer.

16. The apparatus for document markup according to claim 15 further comprising:
a storage medium that stores said corresponding user input and said data position of said selected portion, said storage medium in communication with said memory buffer.

17. The apparatus for document markup according to claim 15 further comprising:
a distributed network, said distributed network in communication with said memory buffer; and
a storage medium that stores said corresponding user input and said data position of said selected portion, said storage medium in communication with said distributed network and said memory buffer.

18. The apparatus for document markup according to claim 15 further comprising:
an integration device that integrates said corresponding user input into said document at said data position, said updating device in communication with said memory buffer.

19. The apparatus for document markup according to claim 18 further comprising:
an updating device that updates said display device so said selected portion of said document is displayed differently than the rest of said document, said updating device in communication with said integration device and said display device.

20. The apparatus for document markup according to claim 15 further comprising:
an indicating device that indicates said corresponding user input and said data position of said selected portion has been stored.

21. The apparatus for document markup according to claim 16 further comprising:
an indicating device that indicates said corresponding user input and said data position of said selected portion has been stored in said storage medium.
